(19) United States
(12) Patent Application Publication
(10) Pub. No.: US 2006/0179433 A1
(43) Pub. Date: Aug. 10, 2006

(54) SYSTEMS AND METHODS FOR REMOTELY ADMINSTERING A TARGET DEVICE

(75) Inventors: Donald T. Fair, Reston, VA (US); Eric B. Cole, Leesburg, VA (US); Evan M. Teran, Alexandria, VA (US)

Correspondence Address: MARTIN & HENSON, P.C., 9250 W 5TH AVENUE, SUITE 200, LAKEWOOD, CO, 80226, US

(73) Assignee: SYTEX, INC., Doylestown, PA (US)

(21) Appl. No.: 11/160,536

(22) Filed: Jun. 28, 2005

Related U.S. Application Data
(63) Continuation of application No. 10/906,144, filed on Feb. 4, 2005.

(51) Int. Cl. G06F 9/445

(52) U.S. Cl. 717/174

(57) ABSTRACT

Methods and systems are provided for remotely administering a target network communications device (NCD) from a launch NCD. System level access to the target NCD is obtained and sets of launch and target tools are respectively installed on the launch and target NCDs. A trigger command corresponding to a data request is transmitted from the launch NCD to the target NCD. Reply data responsive to the request is retrieved at the target NCD and transmitted to the launch NCD. Provided also is a system wherein the first NCD includes a front end trigger component for generating selected trigger commands, and the second NCD includes a response component for the replies. A data transmission component is interfaced between the first and second NCDs.

### BACKGROUND

1) Field of the Invention

The present invention broadly relates to the manipulation or monitoring of one communications device from another via a network. More particularly, the invention relates to remote control or administration of a target computer from a launch computer. To this end, systems, devices and methodologies are provided.

2) Discussion of Related Art

Since its inception in the 1960's as a packet-switched network, the Internet has grown exponentially into a robust, global network connecting millions of computers. Because the Internet provides fast, inexpensive access to information in revolutionary ways, it has emerged from relative obscurity to international prominence. The Internet itself comprises thousands of interconnected computer networks which are able to share information. These individual networks may be of a variety of types, such as local area networks (LANs) and wide-area networks (WANs), to name a few, and may be categorized by various characteristics including topology, communication protocols and network architecture.

It is known to have remote command and control applications with accompanying front-end systems providing a graphical user interface (GUI) for the application. An example of a fully functional front end is NMAP (“Network Mapper”) which is a free open source utility for network exploration or security auditing. In the category of remote administration applications is a program referred to a “Back Orifice” which was once documented on the World Wide Web as a system for allowing a user to control a computer across a TCP/IP connection using a simple console or GUI application. However, the project presently appears to be stagnant in its development and, in any event, not very portable to other operating system platforms. The same holds true for another remote command and control application available written by Carl Fredrik Neikter and referred to as “NetBUS”. Other projects which are known to be available are strictly for Windows machines and fall into the category of remote monitoring but apparently not remote control. These include various computer privacy and Internet security products available from TC-3P online of Winter Springs, Fla. and marketed under the names “eBlaster”, “iSpyNow” and “Net Vizor”.

### BRIEF SUMMARY

In its various forms, the present invention relates to systems and methods for directing the actions of, or monitoring, one network communications device from another. In preferred embodiments of the invention, the controlling device and the controlled device reside on a network infrastructure, such as the Internet or an intranet, and are adapted to exchange information between them via suitable communication links.

In a method for remotely administering a target network communications device (NCD) from a launch NCD, system level access to the target NCD is obtained so that a set of target tools can be installed thereon. The target tools include a loadable kernel module (LKM) responsible for retrieving reply data from the target NCD in response to a data request issued from the launch NCD. A set of launch tools are also installed on the launch NCD for issuing the data request. A trigger command is transmitted corresponding to the data request from the launch NCD to the target NCD. Reply data is retrieved at the target NCD, and then transmitted to the launch NCD.

A system is also described comprising first and second NCDs respectively configured as a launch computer and a target computer. The first NCD includes a front end trigger component having a command and control console for generating selected trigger commands, each corresponding to a data request. The second NCD includes a response component which incorporates an LKM for replying to each data request with a data reply. A data transmission component provides a transmission medium between the two NCDs.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a component diagram for representing a first exemplary embodiment of a command and control system according to the present invention;

FIG. 2 is a diagrammatic view representing another exemplary embodiment of a command and control system according to the invention;

FIG. 3 is a representative deployment diagram for a command and control system according to the invention, such as the system of FIG. 2;

FIG. 4 is a packaging diagram showing the tools for the launch and target computers;

FIGS. 5a-c illustrate screenshots for a representative graphical user interface (GUI) for the invention's front-end command and control console;

FIG. 6 shows represents a decision-making flowchart when incoming packets are detected by the loadable kernel module (LKM) which resides on the target computer;

FIG. 7 represents a high level flowchart for a methodology which implements the functions of one exemplary embodiment of a remote access and control system according to the invention;

FIG. 8 represents an exemplary network communications device that may be configured to implement aspects of the present invention;

FIG. 9a is a diagrammatic view representing another exemplary embodiment of a remote command and control system;

FIG. 9b is a representative deployment for the command and control system of FIG. 9a;

### DETAILED DESCRIPTION

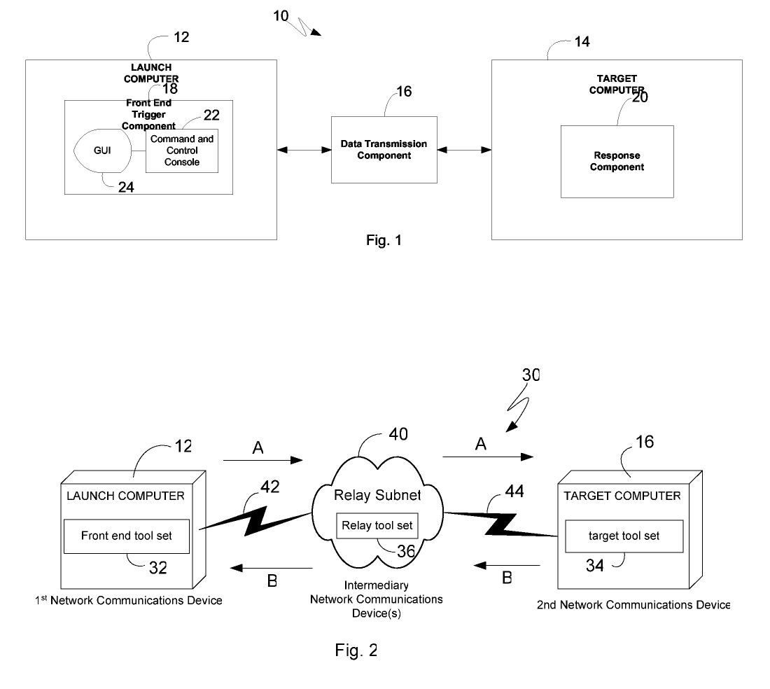

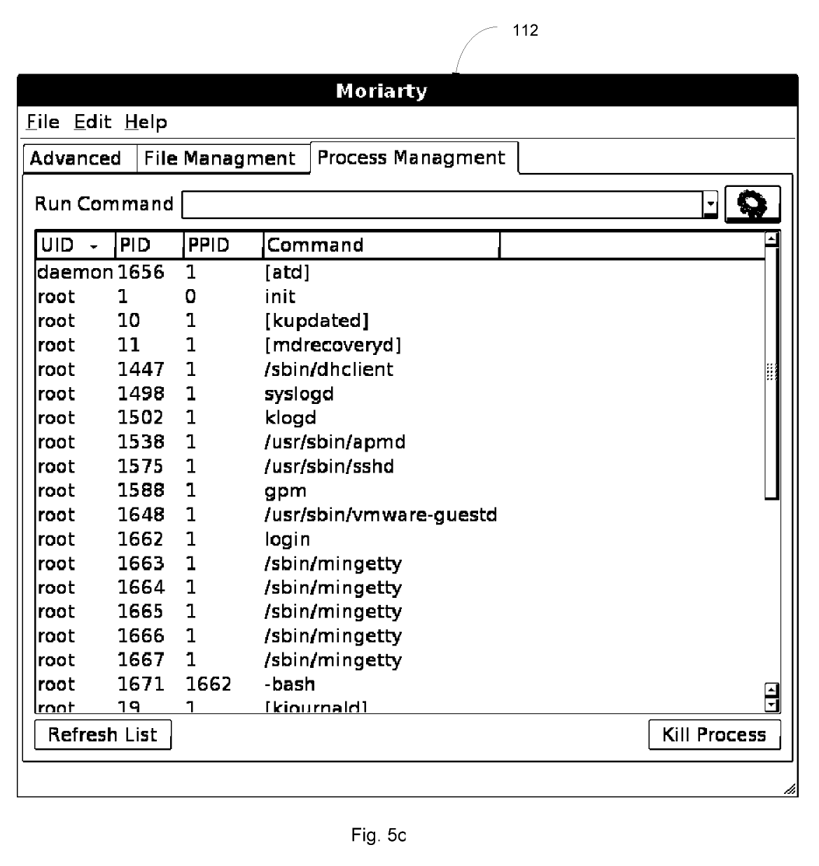

Various embodiments are provided pertaining to the control of one device from another via a network therebetween. In this regard, systems, devices and methodologies are described. Various components for a first exemplary embodiment of a command and control system 10 are shown in FIG. 1. Command and control system 10 includes a first network communications device (1^{st} NCD) 12 referred to as a launch computer and a second network communications (2^{nd} NCD) 14 referred to as a target computer, each of which is preferably adapted to communicate according to a layered communications protocol. A data transmission component 16 functions as an interface between launch computer 12 and target computer 14. A front end trigger component 18 issues data requests to the target computer 14 via transmission component 16. A response component 20 associated with target computer 14 replies to the issued data requests with data replies. Advantageously, the front end trigger component 18 resides on launch computer 12 and preferably includes a command and control console 22 for generating trigger commands corresponding to the data requests, as well as a graphical user interface (GUI) 24, illustrated below in FIGS. 5a-5c.

The requests for data which are issued by the launch computer's trigger component 18 can relate to any suitable data which resides on the target computer, such as files, directories, network status information, etc., which one might be interested in. In this context, data requests encompass those items of information about the target computer which a user of the launch computer identifies via the front end trigger component 18, and not the type of data which is typically exchanged when two network devices establish connections with one another, unless of course, specifically requested by the user through the trigger component.

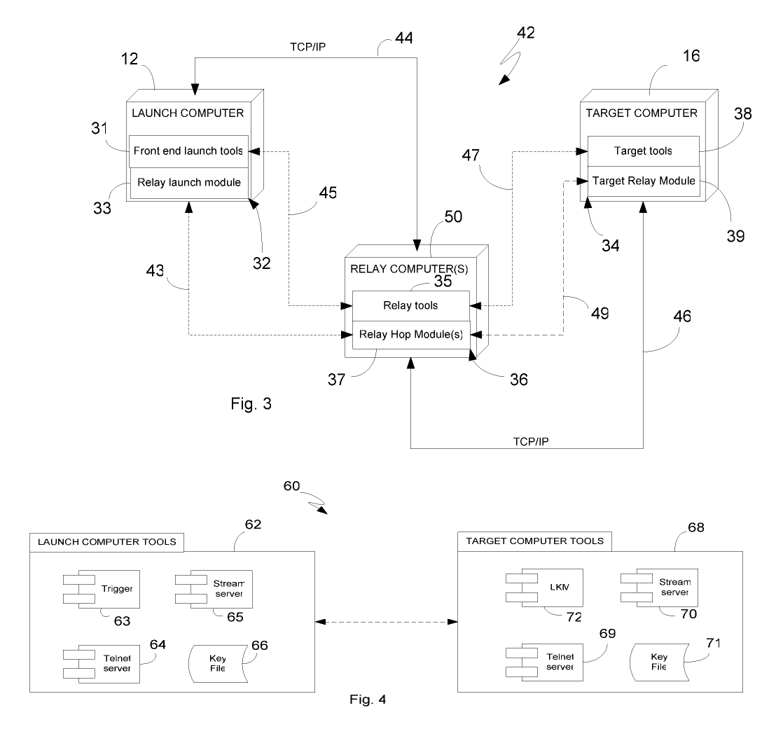

FIG. 2 represents another exemplary embodiment of a system 30. Here, system 30 includes the first and second network devices, i.e. launch computer 12 and target computer 14 respectively, and a relay subnet 40. In system 30, 1^{st} NCD 12 issues its data request to 2^{nd} NCD 16 along a predetermined first relay route defined by relay subnet 40, while 2^{nd} NCD 16 replies along a predetermined second relay route which may also be defined by the same relay subnet 40. The relay subnet 40 may include one or more intermediary NCDs and is configured to forward outbound traffic (arrows “A”) corresponding to the data request to 2^{nd} NCD 16, peferably in a manner which does not reveal 1^{st} NCD 12 as the origin of the data request. Reply traffic (return arrows “B”) from 2^{nd} NCD 16 toward 1^{st} NCD 12 also passes through relay subnet 40 which serves to forward the reply.

To accomplish the functionalities for system 30, each participant component preferably has an associated tool set installed thereon. More particularly, launch computer 12 has an associated front end tool set 32, target computer 16 has an associated target tool set 34, while each intermediary computer within the relay subnet 40 preferably has its own relay tool set 36. In this context, the term “tool set” relates to the various software components which reside on the systems in order to accomplish the functionalities described herein, whether the components be modules, files, servers, etc. Accordingly, the terms “tool set” and “tools” should be construed as broadly as possible within the spirit of the invention.

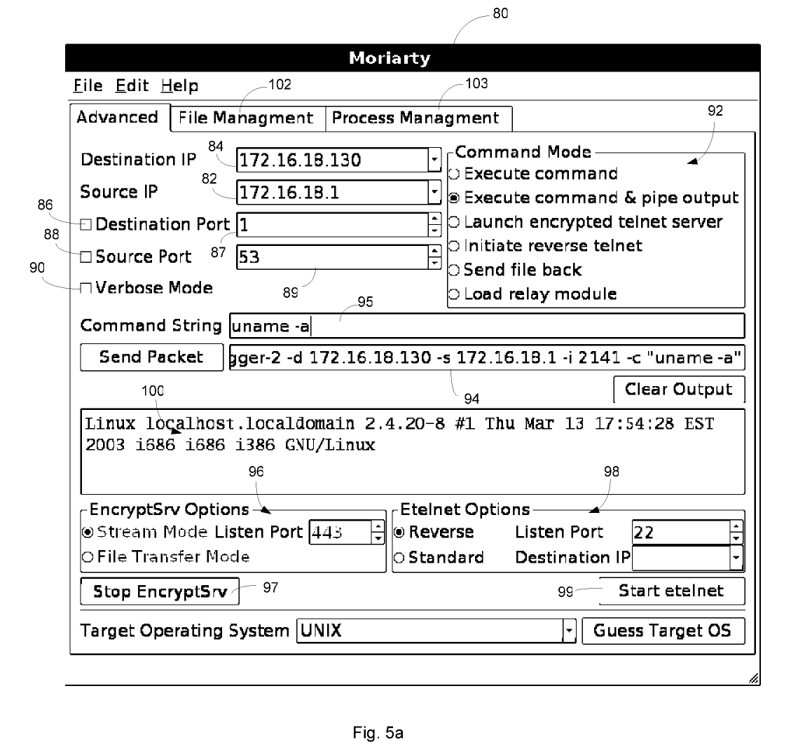

A deployment diagram 42 for the system 30 of FIG. 2 is shown in FIG. 3. Here, it may be seen that launch computer 12, relay computer(s), (generally 50) and the target computer 16 communicate over communication links 44 and 46, preferably in accordance with the TCP/IP suite of protocols, as well known in the art. The communication links 44 and 46 can be any suitable type(s) and configuration(s) in relation to the hardware, software, protocols and access methods applied in the design of the network architectures, without limitation.

The front end tool set 32 for launch computer 12 includes front end launch tools 31 and a relay launch module 33. Each relay tool set 36 for the various relay computer(s) 50 includes associated relay tools 35 and a relay hop module 37. The target tool set 34 includes target tools 38 and an optional target relay module 39. The logical interactions among the various software components are shown by dotted lines 43, 45, 47 and 49 in FIG. 3. Thus, those software components or tools pertaining to the remote access and control of the target computer 16 from the launch computer 12 logically interact with one another, while those components for accomplishing outbound and return transmissions relating to data requests and the replies logically relate to one another but can exist and function independently.

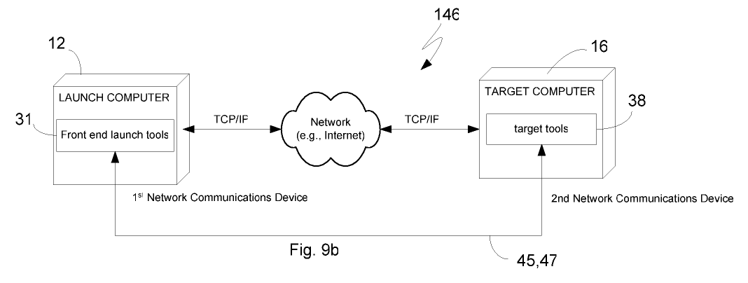

Accordingly, the remote control of a target computer that does not incorporated relaying is contemplated, as illustrated in FIGS. 9a and 9b. In system 130 the 1^{st} and 2^{nd} NCDs, namely the launch computer 12 and target computer 16, communicate via a data distribution network 140 such as the Internet. A deployment diagram 146 for such a system 130 is shown in FIG. 9b whereby the computers preferably communicate via TCP/IP and their software components 31 and 38 logically interact as indicated by 45, 47.

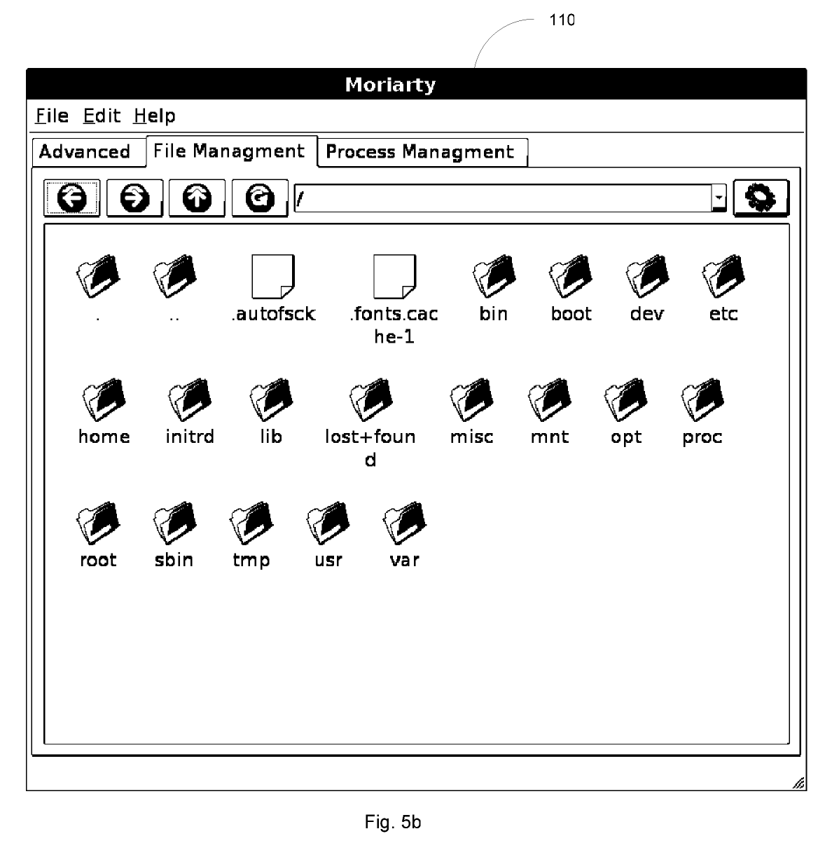

Reference is now made to FIG. 4 which shows a packaging diagram 60 for the various software tools within the launch and target computers as they relate to the command and control capabilities. The tool package 62 for the launch computer shows that the front end launch tools include a trigger 63, a telnet server 64, a stream server 65 and a key file 66. The tools package 68 associated with the target computer also has an associated telnet server 69, stream server 70 and key file 71. In addition, the target tools include an associated loadable kernel module (LKM).

The trigger 63 for launch package 62 may be in the form of a trigger packet program (e.g. a software module) operative during operation to issue the data requests in the form of trigger commands, as mentioned above with reference to the front end trigger component 18. In use, a front end for a command line-based, remote command and control system is thus provided whereby an operator can execute many commands with system level access on the target computer provided system level access has been obtained through some means. Thus, the application on the launch computer, as diagrammatically represented by the package components 63-65, is capable of executing any command on the remote system (i.e. target computer) that a normal user could execute. The system scripts complex commands to provide a “virtual desktop” giving seamless and user friendly control (via the GUI) to the operator. With the trigger 63 a user can request that the remote LKM 72 reply to a variety of data requests based on various flags. The telnet servers 64 and 69 are provided for establishing connections between the launch and target computers and, in a present implementation, the trigger commands are transmitted to the target computer according to the user datagram protocol (UDP). On the target side, the telnet-like server is more or less a standard telnet server with multiple logins and non-essential functionality stripped out. Replies from the target computer may be piped back through encrypted streams by the streams servers 65 and 70 which transmit either files or ASCII streams. In essence, the stream server 70 on the target takes the output of whatever request the launch has asked the LKM 72 to fulfill, and sends it through an encrypted TCP stream back to the launch. Stream server 70 reads the key file 71 and then performs the encryption. It preferably uses standard sockets to open up the TCP stream back to the launch system and send the encrypted data.

The open SSL algorithm, or other suitable approach, may be used to create a public key/private key pair for use during encrypted exchanges. To this end, the target computer will create a session key, encrypt it with the public key and send it to the launch computer. The launch computer then decrypts it with the private key in order to recover the session key, which is particular for that session. Respective key files 66 and 71 reside on the launch and target computers. The key file on the launch side is private and stays on the launch computer, while the key file on the target side is public. Each of these key files stores a common unique key which is used during the initial negotiation to transfer the session key. Thus, each time a new session is established, the session key is encrypted with the same unique key (i.e. the public key) and sent back to the launch system. Necessarily, then, the key file 66 associated with the launch computer system also includes a private key in addition to the unique public key which resides on each system. Of course, the ordinarily skilled artisan will appreciate that a variety of encryption schemes could be employed in order to have encrypted transmissions, for example, synchronous or asynchronous key exchanges coupled with any of a variety of suitable encryption algorithms. Moreover, using encrypted transmissions between the launch and target computers is not a requirement but a preference. It is also preferred to have the encrypted transmissions be in accordance with the transmission control protocol (TCP) and more broadly under the umbrella of IP traffic.

Reference is now made to FIGS. 5a-c which show various screen shots for a representative GUI for the front end command line trigger tool, and representative data is shown in each of the screen shots for purpose of explanation. With initial reference to the screen shot 80 of FIG. 5a, various data input fields may be provided as drop down list boxes to indicate at 82 the source IP address (i.e. the launch computer) from which the data request will be transmitted, and at 84 the destination IP address (i.e. the target computer) from which the request will be fulfilled. Check boxes 86 and 88, respectively, are provided to indicate desired destination and source ports for the trigger request, which are then identified within boxes 87 and 89, respectively. Another check box 90 is provided to indicate whether verbose mode is desired, which causes the entire trigger command to be presented to the user, as opposed to an abbreviated representation.

A group of command mode radio buttons, generally 92, are provided from which the operator of the launch computer selects various operational modes. The first two command modes shown will execute the command provided in field 94 and, optionally, pipe it out to the target computer. A command string field 95 is provided from which the operator can input additional flags, as desired. A radio button is also provided for launching the encrypted telnet server, whose port number may be input into field 95. Similarly, if desired, reverse telnet capability is available by selecting the next radio button down. A radio button is also provided for sending a file back from the target computer, and the file may be designated in field 95. Finally, a radio button is provided to indicate the action of loading the relay module onto the target computer or one of the relay computers, as needed.

Various encryption options are provided generally at 96 to indicate the selected mode and ports for encryption, which is initiated upon activating button 97. If the user selects stream mode then results of the command, as they would otherwise be seen on the target computer, are piped back and displayed in window 100. In file transfer mode, the results are saved in a file. Telnet options are also provided generally at 98 and are initiated upon activating button 99. Selection of the “file management” tab 102 and the “process management” tab 103 brings up windows 110 and 112 shown in FIGS. 5b and c, respectively. Window 110 is populated with a file listing for the target computer, as determined by the destination IP identified in field 84 of FIG. 5a, and this file listing can be navigated through conventional means. Similarly, window 112 is populated with a listing of running processes on the target computer.

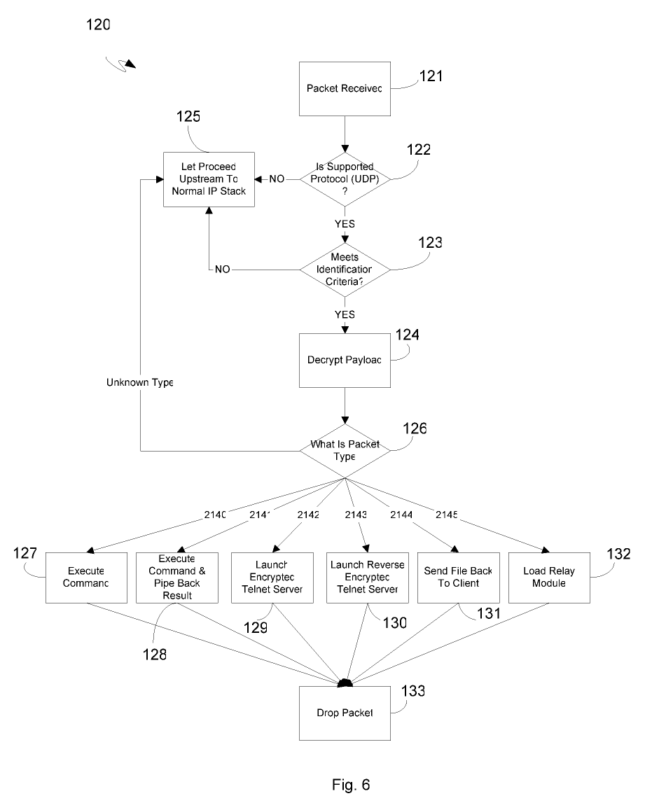

A flow diagram 120 is shown in FIG. 6 to illustrate the decision-making that takes place when incoming packets are detected by the loadable kernel module (LKM) residing on the target computer. When a packet is received at 121, a determination is made at 122 as to whether the packet's supported protocol is UDP. If the packet additionally meets the identification criteria at 123, such as having the unique relay protocol number “5”, then its payload is decrypted at 124. If the received packet is not supported by UDP or its other identification criteria is not met, then it is allowed to proceed upstream to the normal IP stack at 125. Otherwise, once the packet's payload is decrypted at 124, a determination is made at 126 as to what type of packet it is. That is, the LKM determines what type of request is being made by the launch computer, each of which is indicated by boxes 127-132. Each type of request has an associated numerical designator which corresponds to that which populates screen shot 80 in FIG. 5a based on the user's selections at the launch computer. The LKM will then drop the packet at 133 once the request has been satisfied.

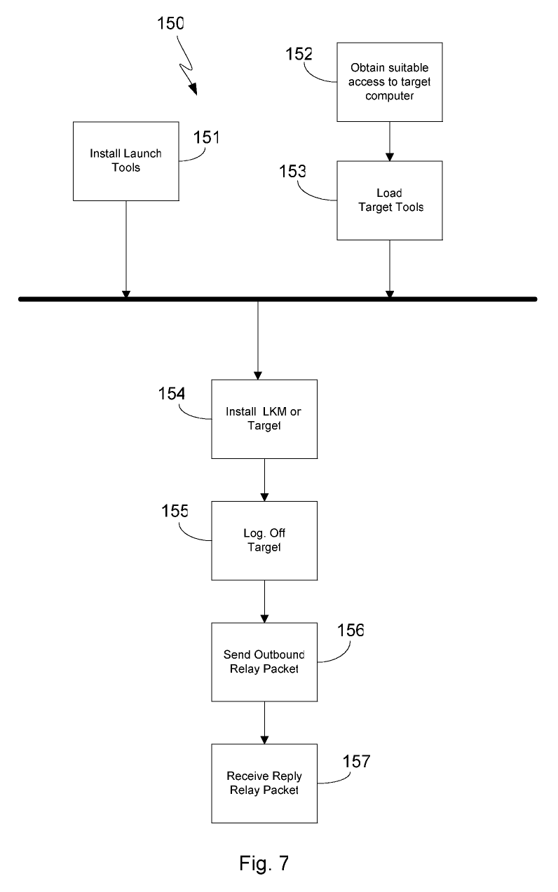

With an appreciation of the above description pertaining to the command and control capabilities, a method 150 (FIG. 7) may be practiced for remotely accessing and controlling a target computer from a launch computer. According to method 150, a set of launch tools is installed at 151 on the launch computer. System level access is obtained for the target computer at 154 since, for purposes of the description, it is assumed that one has administrative rights (i.e. root level access) on the target machine by some means. In any event, once system level access is obtained, a set of target tools is loaded on the target computer at 153, such as by uploading them or otherwise. The target tools preferably include the LKM responsible for retrieving reply data from the target computer in response to a data request issued from the launch computer. Operation 153 might correspond, for example, to the selection of the radio button discussed above in FIG. 5a. It is preferred that the set of target tools be uploaded as compiled programs to a directory within the file system on the target computer's hard disk which is either hidden, such as by a rootkit, or any other suitable location where the authorized user of the target computer would not normally write to or otherwise access. To this end, if the target computer is a Linux or any Unix-like machine, the /dev directory might be appropriate.

At 154 the LKM is installed on the target computer. After logging off at 155, an outbound packet is sent at 156 which contains the data request. The outbound packet is preferably sent along a predetermined outbound relay route from the launch computer to the target computer. At 157, a reply packet is received from the target computer in response to the outbound transmission packet. This reply packet is preferably one which also traveled along a predetermined return relay route from the target computer to the launch computer.

The purpose of the set of target tools which are uploaded is to allow an operator to reconnect to the target without having to regain system level access or otherwise compromise the machine. Thus, the target tools provide, in part, a sustainable back door (i.e. re-entry) into the target machine. The LKM which is installed is installed via known approaches, such as with the insmod function on Linux machines, and scripts are preferably employed to ensure that it gets reloaded each time the target system is shut down and restarted. As with the other tools, if desired, they can all be hidden by a suitable rootkit in an effort to avoid inadvertent or intentional tampering.

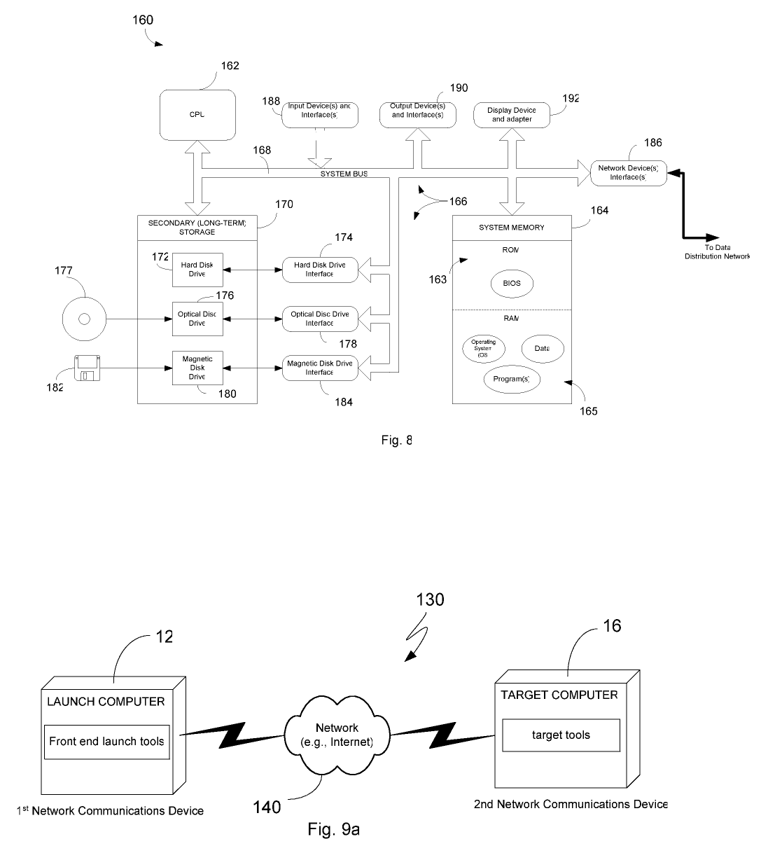

Each network communications device involved in the described systems is considered to be a participant which may be configured as a general purpose computer system 160 such as representatively depicted in FIG. 8. System 160 includes a processing unit, such as CPU 162, a system memory 164 and an input output (I/O) system, generally 166. These various components are interconnected by system bus 168 which may be any of a variety of bus architectures. System memory 164 may include both non-volatile read only memory (ROM) 163 and volatile memory such as static or dynamic random access memory (RAM) 165. Programmable read only memories (PROMs), erasable programmable read only memories (EPROMs) or electronically erasable programmable read only memories (EEPROMs) may be provided. ROM portion 163 stores a basic input/output system (BIOS) as shown. RAM portion 165 can store the OS (preferably having the necessary LKMs and network stacks), data, and/or programs such as the trigger console, the telnet server and the stream server. Computer system 160 may be adapted to execute in any of the well-known operating system environments, such as Windows, UNIX, MAC-OS, OS2, PC-DOS, DOS, etc.

Various types of storage devices can be provided as more permanent data storage areas which can be either read from or written to, such as contemplated by secondary storage region 170. Such devices may, for example, include a permanent storage device in the form of a large-capacity hard disk drive 172 which is connected to the system bus 168 by a hard disk drive interface 174. An optical disk drive 176 for use with a removable optical disk 177 such as a CD-ROM, DVD-ROM or other optical media, may also be provided and interfaced to system bus 168 by an associated optical disk drive interface 178. Computer system 160 may also have one or more magnetic disk drives 180 for receiving removable storage such as a floppy disk or other magnetic media 182 which itself is connected to system bus 168 via magnetic disk drive interface 184. Remote storage over a network is also contemplated.

System 160 may be adapted to communicate with a data distribution network (e.g., LAN, WAN, the Internet, etc.) via communication link(s). Establishing the network communication is aided by one or more network device(s) interface(s) 186, such as a network interface card (NIC), a modem or the like which is suitably adapted for connection to the system bus 168. System 160 preferably also operates with various input and output devices as part of I/O system 166. For example, user commands or other input data may be provided by any of a variety of known types of input devices and associated system bus interfaces, generally 188. One or more output devices with associated system bus interfaces, generally 190, may also be provided. A monitor or other suitable display device and its suitable adapter, generally 192, may also be connected to the system bus 168.

One or more of the memory or storage regions mentioned above may comprise suitable media for storing programming code, data structures, computer-readable instructions or other data types for the computer system 160. Such information is then executable by processor 162 so that the computer system 160 can be configured to embody the capabilities described herein. Alternatively, the software may be distributed over an appropriate communications interface so that it can be installed on the user's computer system.

Although certain aspects for the various participant computer systems may be preferred in the illustrative embodiments, the present invention should not be unduly limited as to the type of computers on which it runs, and it should be readily understood that the present invention indeed contemplates use in conjunction with any appropriate network communications device having the capability of being configured in a manner for accommodating the invention. Moreover, it should be recognized that the invention could be adapted for use on computers other than general purpose computers, as well as on general purpose computers without conventional operating systems.

As concerns the command and control component, an implementation has been designed and coded with python and XML such that it may be portable by nature to any platform supporting the client machine (currently Solaris, FreeBSD, Linux and Windows). It is also compilable on many POSIX compliant systems. The interface has been defined in XML, as defined by the glade-2 specification. Glade-2 is a GUI builder which is based on the Gimp tool kit that is currently available via the web address http://glade.gnome.org/. This is a rapid development tool which allows for quick and easy modification of the actual interface. The actual python program loads this XML at runtime and performs tasks based on input from the operator. It executes all commands through running a new instance of the base client program and capturing its “standard out” and “standard error” through which feedback is provided to the operator. It may also execute many commands before giving feedback to provide a single operation experience for the user when appropriate.

Presently, the system is designed to be as non-overt as possible. It uses minimal Internet traffic to provide its services and all communications are encoded when appropriate to ensure a reasonable level of security. To this end, as few packets as possible are sent and received between the participants, reducing the chance of packet capture or reverse engineering. Presently, encryption is accomplished through the blowfish protocol which has the appeal of not requiring any additional space for the encryption and, as mentioned above, the encryption is dependant on both the target and launch sharing a common encryption/decryption key (the unique key) which is defined at compile time. A key exchange encryption system, though, could be alternatively employed. Also contemplated is the ability to extend the functionality of the front end by making it more automated through the use of options capable of assembling the equivalent of many commands for execution through apparent atomic operation to the user. For example, contemplated is a graphical file transfer mode to allow drag and drop file transfers.

The development tools mentioned above are the preferred tools utilized by the inventors but should not be interpreted to limit the environment of the present invention. Software embodying the various software components described, for example in FIG. 3, may be distributed in known manners which are suitable, such as on computer-readable media containing the executable instructions for performing the methodologies discussed. Alternatively, the software may be distributed over an appropriate communications interface to be installed on the various computer systems.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

What is claimed is:

1. A method for remotely administering a target network communications device (NCD) from a launch network communications device (NCD), comprising:
a. obtaining system level access to the target NCD;
b. installing a set of launch tools on the launch NCD;
c. installing a set of target tools to the target NCD, wherein said set of target tools includes a loadable kernel module (LKM) responsible for retrieving reply data from the target NCD in response to a data request issued from the launch NCD;
d. transmitting a trigger command corresponding to said data request from the launch NCD to the target NCD;
e. retrieving reply data responsive to said data request at the target NCD; and
f. transmitting said reply data to the launch NCD.

2. A method according to claim 1 whereby system level access is gained by installing a rootkit on the second NCD.

3. A method according to claim 1 whereby the set of target tools is uploaded to the target NCD.

4. A method according to claim 1 whereby the set of launch tools includes:
a. a front end trigger component for issuing said data request to the second NCD;
b. a telnet server for establishing a connection to the second NCD; and
c. a stream server for permitting encrypted transmission of the data request to the second NCD.

5. A method according to claim 1 whereby said set of target tools further includes:
a. a telnet server for establishing a connection to the launch NCD; and
b. a stream server for permitting encrypted transmission of the reply data to the launch NCD.

6. A method according to claim 5 whereby each of the set of launch tools and the set of target tools further includes an associated key file storing a unique key used for encrypted transmissions therebetween.

7. A method according to claim 1 whereby said LKM is installed in a location on the second NCD which is not expected to be accessed by an authorized user of the second NCD.

8. A method according to claim 7 whereby said location is on a hard disk associated with the second NCD.

9. A method according to claim 1 whereby said LKM listens for and responds to said trigger command from the first NCD.

10. A method according to claim 1 whereby said LKM is installed into a kernel of the second NCD such that it is reloaded each time the second NCD is restarted after a shutdown.

11. A method according to claim 1 whereby said trigger command is transmitted via the user datagram protocol (UDP).

12. A method according to claim 1 comprising logging off the target NCD prior to transmission of said trigger command.

13. A method for remotely administering a target network communications device (NCD) from a launch network communications device (NCD), comprising:
a. obtaining system level access to the target NCD;
b. installing a set of launch tools on the launch NCD;
c. installing a set of target tools to the target NCD, wherein said set of target tools includes a loadable kernel module (LKM) responsible for retrieving reply data from the target NCD in response to a data request issued from the launch NCD;
d. means for transmitting a trigger command corresponding to said data request from the launch NCD to the target NCD;
e. means for retrieving reply data responsive to said data request at the target NCD; and
f. means for transmitting said reply data to the launch NCD.

14. A system, comprising:
a. a first network communications device (NCD) configured as a launch computer that includes a front end trigger component having a command and control console for generating selected trigger commands, each corresponding to a data request;
b. a second network communications device (NCD) configured as a target computer that includes a response component which incorporates a loadable kernel module (LKM) for replying to each said data request with a data reply; and
c. a data transmission component for transmitting said data request from the first NCD to the second NCD and for transmitting said data reply from the second NCD to the first NCD.

15. A system according to claim 14 wherein said trigger commands are transmitted to the second NCD according to the user data protocol (UDP).

16. A system according to claim 14 wherein each of said first and second NCDs includes an associated telnet server for establishing connections therebetween.

17. A system according to claim 14 wherein each of the first and second NCDs includes an associated stream server to permit encrypted transmissions therebetween.

18. A system according to claim 15 wherein said encrypted transmissions are in accordance with the transmission control protocol (TCP).

19. A system according to claim 16 wherein each of said first and second NCDs stores a unique key used for encrypting the transmissions therebetween.

20. A system according to claim 14 wherein said data transmission component comprises an outbound relay subnet including at least one outbound relay computer for forwarding data requests originating from the first NCD toward the second NCD, and a return relay subnet including at least one return relay component for forwarding said data replies from the second NCD toward the first NCD.
